(19) United States
(12) Patent Application Publication
(10) Pub. No.: US 2026/0097623 A1
(43) Pub. Date: Apr. 9, 2026

(54) OPTIMAL TEMPERATURE AND FLOW CONTROL AND ESTIMATION IN THERMAL SYSTEM MANAGEMENT FOR ELECTRIFIED VEHICLES

(71) Applicant: FCA US LLC, Auburn Hills, MI (US)

(72) Inventors: Mojtaba Kordestani, Auburn Hills, MI (US); Milad Karimshoushtan, Auburn Hills, MI (US); Alireza Fatehi, Auburn Hills, MI (US); Islam Benouaguef, Auburn Hills, MI (US); Ali Sina Shojaei, Auburn Hills, MI (US); Kamal Bouyoucef, Auburn Hills, MI (US); Feisel Weslati, Auburn Hills, MI (US)

(21) Appl. No.: 18/908,872

(22) Filed: Oct. 8, 2024

(51) Int. Cl. B60H 1/00

(52) U.S. Cl. CPC B60H 1/00392; B60H 2001/00307

(57) ABSTRACT

An optimal control method for a vehicle thermal system includes providing a set of sensors configured to measure a set of operating parameters of the thermal system and a set of actuators configured to control flow and temperature of a coolant through the thermal system and performing, by a vehicle controller, linear-quadratic-Gaussian (LQG) optimal control of the thermal system by generating, using the set of sensors and the set of actuators and a sampling time, inputs for a state-space model of the thermal system, identifying the state-space model of the thermal system using a sub-space method, obtaining a Kalman filter to estimate states of the state-space model at each sampling time, calculating flows through the thermal system using the estimated states and diagonal matrix properties, and applying an optimal control to compute a gain and values of each of the set of actuators at each sampling time.

### FIELD

The present application generally relates to vehicle thermal systems and, more particularly, to optimal temperature and flow control and estimation in thermal system management for electrified vehicles (EVs).

### BACKGROUND

Vehicles, such as automobiles, often include one or more thermal systems (e.g., coolant loops) for regulating the temperature of associated vehicle components. In an electrified vehicle (EV), for example, a low temperature loop (LTL) can include one or more electric drive modules (EDMs) and an integrated dual charging module (IDCM). This LTL further includes various actuators (pumps, a radiator/fan, a valve, etc.) that control the flow and temperature of the coolant through the LTL. Conventional techniques for controlling temperature and coolant flow in this LTL (via control of the actuator settings) are based on empirical data (e.g., stored in look-up tables, or LUTs). These conventional techniques require substantial calibration effort, thereby increasing costs, and are also inaccurate and inefficient, thereby wasting vehicle energy. Accordingly, while these conventional vehicle thermal system management techniques do work for their intended purpose, there exists an opportunity for improvement in the relevant art.

### SUMMARY

According to one example aspect of the invention, a control system for a thermal system of a vehicle is presented. In one exemplary implementation, the control system comprises a set of sensors configured to measure a set of operating parameters of the thermal system and a set of actuators configured to control flow and temperature of a coolant through the thermal system and a controller configured to perform linear-quadratic-Gaussian (LQG) optimal control of the thermal system by generating, using the set of sensors and the set of actuators and a sampling time, inputs for a state-space model of the thermal system, identifying the state-space model of the thermal system using a sub-space method, obtaining a Kalman filter to estimate states of the state-space model at each sampling time, calculating flows through the thermal system using estimated states and diagonal matrix properties, and applying an optimal control to compute a gain and values of each of the set of actuators at each sampling time.

In some implementations, the vehicle is an electrified vehicle (EV) and the thermal system is associated with one or more electric drive modules (EDMs) of the EV. In some implementations, the thermal system is a low temperature loop (LTL) associated with a front EDM, a rear EDM, and an integrated dual charging module (IDCM) of the EV. In some implementations, the set of actuators and the includes first and second pumps, a radiator fan, and a valve and the set of sensors include a pump inlet temperature sensor, the inputs to the state-space model include speeds of the first and second pumps and the radiator fan and a position of the valve, and the outputs of the state-space model include fluid flow through the first and second pumps and coolant temperature.

In some implementations, the generating of the input data for and the identifying of the state-space model using the sub-space method further includes using pseudorandom binary sequences (PRBS) for generating the inputs. In some implementations, the identifying of the state-space model using the sub-space method includes constructing a matrix having a diagonal format.

In some implementations, the controller is configured to perform the LQG optimal control of the thermal system using the computed gains and values for the set of actuators. In some implementations, the LQG optimal control of the thermal system decreases vehicle energy consumption due to inaccurate control of the thermal system. In some implementations, the controller is configured to perform the LQG optimal control of the thermal system without using empirical calibration data stored in look-up tables (LUTs).

According to another aspect of the invention, an optimal control method for a thermal system of a vehicle is presented. In one exemplary implementation, the optimal control method comprises providing a set of sensors configured to measure a set of operating parameters of the thermal system and a set of actuators configured to control flow and temperature of a coolant through the thermal system and performing, by a controller of the vehicle, LQG optimal control of the thermal system by generating, using the set of sensors and the set of actuators and a sampling time, inputs for a state-space model of the thermal system, identifying the state-space model of the thermal system using a sub-space method, obtaining a Kalman filter to estimate states of the state-space model at each sampling time, calculating flows through the thermal system using the estimated states and diagonal matrix properties, and applying an optimal control to compute a gain and values of each of the set of actuators at each sampling time.

In some implementations, the vehicle is an EV and the thermal system is associated with one or more EDMs of the EV. In some implementations, the thermal system is an LTL associated with a front EDM, a rear EDM, and an IDCM of the EV. In some implementations, the set of actuators and the includes first and second pumps, a radiator fan, and a valve and the set of sensors include a pump inlet temperature sensor, the inputs to the state-space model include speeds of the first and second pumps and the radiator fan and a position of the valve, and the outputs of the state-space model include fluid flow through the first and second pumps and coolant temperature.

In some implementations, the generating of the input data for and the identifying of the state-space model using the sub-space method further includes using PRBS for generating the inputs. In some implementations, the identifying of the state-space model using the sub-space method includes constructing a matrix having a diagonal format.

In some implementations, the controller is configured to perform the LQG optimal control of the thermal system using the computed gains and values for the set of actuators. In some implementations, the LQG optimal control of the thermal system decreases vehicle energy consumption due to inaccurate control of the thermal system. In some implementations, the controller is configured to perform the LQG optimal control of the thermal system without using empirical calibration data stored in LUTs.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B depict functional block diagrams of an electrified vehicle (EV) and an example optimal control system for an example thermal system of the EV according to the principles of the present application;

FIGS. 2A-2B depict functional block diagrams of an example system identification approach and an example architecture for the optimal control system according to the principles of the present application; and

FIG. 3 is a flow diagram of an example optimal control method for a thermal system of a vehicle, such as the EV of FIGS. 1A-1B, according to the principles of the present application.

### DESCRIPTION

As previously discussed, vehicles, such as automobiles, often include one or more thermal systems (e.g., coolant loops) for regulating the temperature of associated vehicle components. In an electrified vehicle (EV), for example, a low temperature loop (LTL) can include one or more electric drive modules (EDMs) and an integrated dual charging module (IDCM). This LTL further includes various actuators (pumps, a radiator/fan, a valve, etc.) that control the flow and temperature of the coolant through the LTL. Conventional techniques for controlling temperature and coolant flow in the LTL are based on empirical data (e.g., stored in look-up tables, or LUTs). These techniques require substantial calibration effort to collect this extensive empirical calibration data across different operating conditions/temperatures, thereby increasing vehicle costs, and these conventional techniques tare also inaccurate and inefficient, thereby wasting vehicle energy. Accordingly, improved optimal (e.g., model predictive) control techniques for a vehicle thermal system are presented herein.

These techniques utilize a linear-quadratic-Gaussian (LQG) controller to perform optimal control of a vehicle thermal system (e.g., the LTL of an EV). An LQG controller generally comprises (i) a linear-quadratic state estimator (LQE) together with a linear-quadratic regulator (LQR). The process includes (1) generating input to obtain a state-space model using sets of sensors/actuators of the thermal system and a sampling time, (2) identify the state-space model using a sub-space method such that an output matrix of the state-space model has a diagonal format, (3) apply an LQE (e.g., a Kalman filter observer) to estimate the states at each sampling time, (4) calculating flows through the thermal system based on outputs of the state-space model (e.g., leveraging the diagonal matrix format), and (5) apply an optimal control (e.g., an LQR) to determine the gain and values of the actuators at each sampling time.

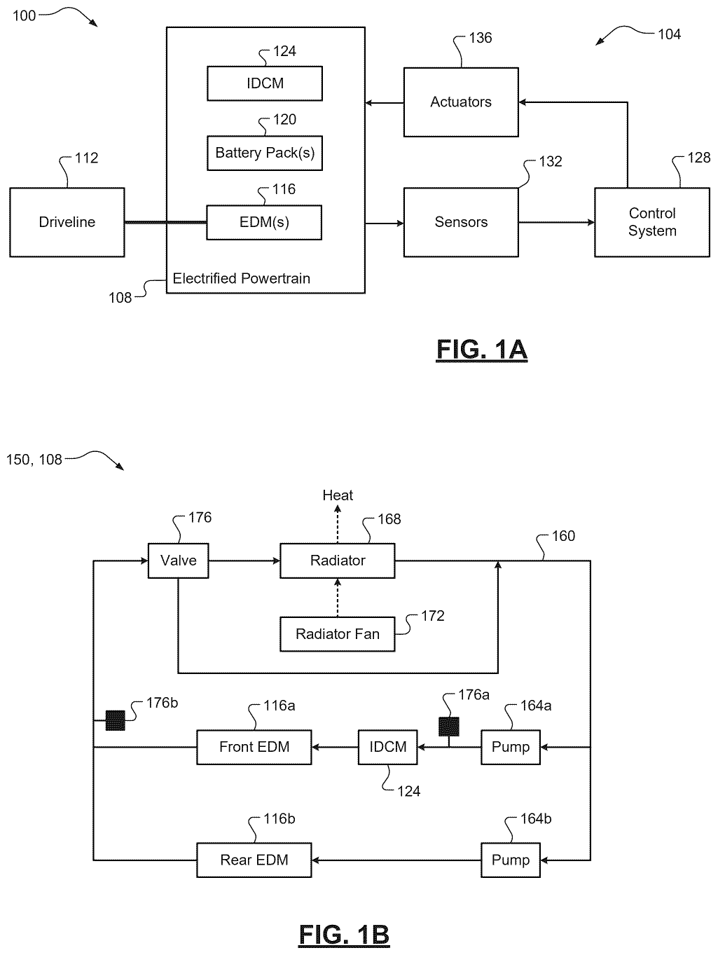

Referring now to FIG. 1A, a functional block diagram depicting an example EV 100 (also “vehicle 100”) including an example optimal control system 104 for an electrified powertrain 108 according to the principles of the present application is illustrated. The electrified powertrain 108 is configured to generate and transfer drive torque to a driveline 112 for vehicle propulsion. The electrified powertrain 108 includes one or more EDMs 116 powered by one or more battery packs or systems 120 and configured to generate and transfer drive torque to the driveline 112. For example, each EDM 116 could include an electric motor, a gear reducer or gearbox, and motor control electronics. In one exemplary implementation as shown in FIG. 1B, the EV 100 includes a front EDM 116a (associated with a front axle of the driveline 112) and a rear EDM 116b (associated with a separate rear axle of the driveline 112). The electrified powertrain 108 also includes an integrated dual charging module (IDCM) 124 configured to control recharging of the battery system(s) 120 (e.g. via electrified vehicle supply equipment, or EVSE) and an optional internal combustion engine (not shown), e.g., for powering a motor-generator unit for recharging the battery system(s) 120).

Operation of the EV 100 is controlled by a controller or control system 128. While a single control system 128 is shown and described herein, it will be appreciated that the control system 128 includes multiple control units or modules connected in a controller area network (CAN). Using different modules, the control system 128 controls different aspects of the electrified powertrain, such as torque management and thermal management. It will be appreciated that a certain module/unit of the control system 128 controls electrified powertrain 108 to generate a desired amount of drive torque to satisfy a driver torque request, which could be provided by a driver via a driver interface (e.g., an accelerator pedal). The driver interface could be one of a plurality of input/output devices, also referred to as sensors 132 and actuators 136. It will also be appreciated that a certain module/unit of the control system 128 controls a thermal system to control a temperature of components of the electrified powertrain 108 (specifically, the EDM(s) 116 and the IDCM 124). While a low temperature loop (LTL) embodiment configured for cooling the electrified powertrain 112 is specifically described herein, it will be appreciated that the thermal system could also be another suitable type of thermal system. It will also be appreciated that the thermal system (shown in FIG. 1B and discussed in greater detail below) could include some of the sensors 132 and actuators 136.

Referring now to FIG. 1B and with continued reference to FIG. 1A, a functional block diagram depicting an example thermal system 150 within the electrified powertrain 108 according to the principles of the present application is illustrated. As shown, an LTL 160 has a coolant flowing therethrough and the LTL 160 is associated with the front EDM 116a, the rear EDM 116b, and the IDCM 124. From actuators 136, the LTL 160 includes a first coolant pump 164a, a second coolant pump 164b, a radiator 168, a radiator fan 172, and a three-way valve 176. It will be appreciated that the LTL 160 could also include other suitable non-illustrated components (e.g., check valves) to prevent coolant from flowing in an undesired direction through the LTL 160. From sensors 132, the LTL 160 includes a first temperature sensor 176a (at an outlet of the first pump 164a) and a second temperature sensor 176b (after the IDCM 124 and the EDMs 116). By controlling the various actuators 136, the flow of the coolant through the LTL 160 is controlled and thereby the temperature of the components (e.g., cooling of the IDCM 124 and the EDMs 116) is also controlled.

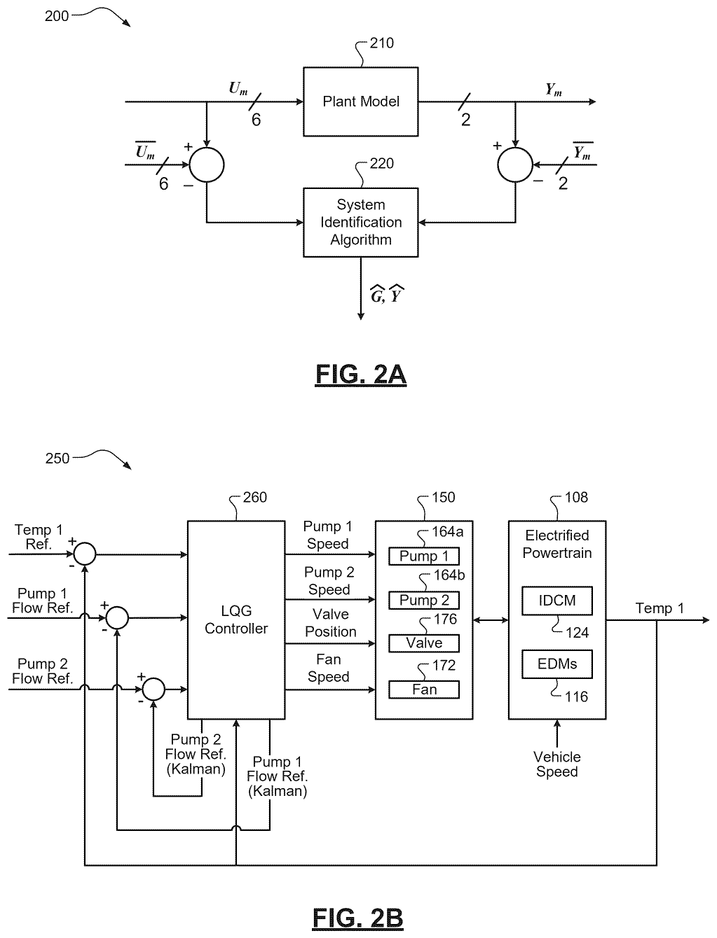

Referring now to FIG. 2A and with continued reference to FIGS. 1A-1B, a functional block diagram depicting a system identification approach for the optimal control system 104 according to the principles of the present application is illustrated. In the first aspect of the techniques of the present application, system identification is performed. System identification is utilized to obtain a mathematical model using sets of test or experimental data. Different approaches can be used to develop this model including, but not limited to, linear time-invariant (LTI) and multi-input multi-output (MIMO) structures that are suitable for modelling a large class of industrial systems. FIG. 2A illustrates a general block diagram of the system identification approach including a plant model 210 and a system identification algorithm 220. Based on the structure of FIG. 2A, the model can be described with the following equation:

$$\hat{Y} = {GU}_{m} + \overline{{Y}_{m}} - \hat{G} \overline{{U}_{m}} , \qquad ( 1 )$$

where Uₘ and Yₘ are the input/output excitation data and Uₘ and Yₘ are their corresponding mean (average) values, respectively.

Without loss of generality and for controller design, Equation (1) can be rewritten as given below:

$$\hat{Y} = \hat{G} {U}_{m} + {Y}_{off} , \qquad ( 2 )$$

$${Y}_{off} = {Y}_{m} - {( \hat{G} \overline{{U}_{m}} )}_{ss} , \qquad ( 3 )$$

where (ĜU̅ₘ̅)ₛₛ is defined as a final or steady-state value of (ĜU̅ₘ̅). To develop the system identification model, data can be obtained from any representative one-dimensional (1D) dynamic model of the thermal system 150. In the case of the example LTL 160, the speed of pumps 164a and 164b, the speed of the radiator fan 168, and the position of the valve 172 are used as inputs, while the outputs are the coolant flow through each pump 164a, 164b and the coolant temperature at the outlet of the pumps (e.g., temperature at sensor 176a). In one exemplary implementation, pseudorandom binary sequences (PRBS) are chosen for the data generation in inputs. Then, the output data of temperature sensor 176a and the flow rates of pumps 164a, 164b are collected.

Using the collected data, a state-space model directly from input-output data can be obtained using the sub-space method as follows:

$$x ( k + 1 ) = Ax ( k ) + Bu ( k ) , and \qquad ( 4 )$$

$$y ( k ) = Cx ( k ) + {y}_{off}$$

$$where :$$

$$u = [ \begin{matrix}{u}_{pump 1} \\ {u}_{pump 2} \\ {u}_{fan} \\ {u}_{valve}\end{matrix} ] and y = [ \begin{matrix}{Temp}_{1} \\ {Flow}_{pump 1} \\ {Flow}_{pump 2}\end{matrix} ]$$

represent the control input and the control output, respectively, pump1 and pump2 refer to pumps 164a and 164b, respectively, and Temp1 refers to the temperature measured by temperature sensor(s) 176a and/or 176b. A, B, and C are matrices of system, input, and output, respectively, which have been identified via PRBS signals based on the sub-space method in such a way that matrix C is constructed in a diagonal format.

Referring now to FIG. 2B and with continued reference to FIGS. 1A-1B and 2A, a functional block diagram depicting an example architecture 250 for the optimal control system 104 according to the principles of the present application is illustrated. The LQG control technique of the present application utilizes the state-space model in Equation (4) and applies a cost function optimization approach to make a trade-off between control effort and output performance. The LQG control design procedure consists of two steps. First, assuming that the state is measurable, an optimal quadratic controller (e.g., an LQR) is designed. Then, an LQE (e.g., a Kalman filter observer) is applied to estimate the unmeasured state using the input and output vectors of the system. Furthermore, because matrix C was purposefully created to be diagonal, the values of the outputs are equal to the states and therefore using state estimator can observe coolant flows through the pumps 164a, 164b. The five key steps of the present invention, which have been discussed in detail above, can be summarized as follows:

First, input data for system identification in the actuators 136 of the thermal system 150 (pump 164a, pump 164b, fan 172, and valve 176) is generated and collected data from the sensors 132 of the thermal system 150 (e.g., coolant temperature(s) and coolant flows through pump 164a and pump 164b). Second, the state-space model is identified using the sub-space method such that the output matrix (C) has a diagonal format. Third, an LQE (e.g., a Kalman filter observer) is obtained to estimate the states at each sampling time. Fourth, the coolant pump flows are calculated using estimated states and the diagonal properties of the output matrix C. Fifth and finally, an optimal control (e.g., LQR) is applied to compute the gain and values of the actuators 136 at each sampling time. This specific strategy is applied to cool down the EDMs 116a, 116b via the radiator 168 and radiator fan 172 very efficiently based on optimal control, which is very cost efficient compared to conventional techniques that rely upon empirical data (e.g., stored in LUTs). Further, this strategy is very efficient as it is model-based and uses a Kalman filter to observe the coolant flows accurately, thereby resulting in a better cool-down approach using the more accurate values. This optimal control also reduces energy consumption.

In yet another extension of the present techniques, the strategy could also be used to estimate the coolant temperature (Temp1) using the Kalman filter and then determine if one or more of the temperature sensors 176a, 176b is faulty (e.g., if the sensor value reading is too far away from the optimal estimate, this could be an indication that the sensor has suffered a fault or other malfunction).

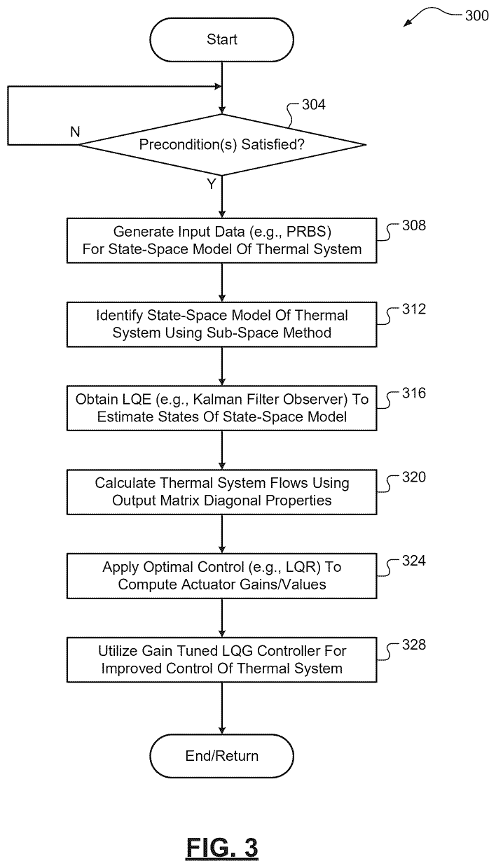

Referring now to FIG. 3 and with continued reference to FIGS. 1A-1B and 2A-2B, a flow diagram depicting an example optimal control method 300 for a thermal system of a vehicle according to the principles of the present application is illustrated. While the method 300 specifically references the EV 100 and the specific thermal system 150 (e.g., LTL 160), it will be appreciated that this method 300 could be applicable to any suitable vehicles (automobiles, trains, marine, aircraft, etc.). It will also be appreciated that this method 300 could be applicable to thermal systems or loops in other non-vehicle applications, such as industrial heating/cooling systems. The method 300 begins at optional 304 where a check to determine whether a set of one or more preconditions are satisfied. This could include, for example only, the EV 100 being operable and there being no faults or malfunctions present that would negatively impact or otherwise inhibit the operation of the techniques of the present application. When false, the method 300 ends or returns to 304. When true, the method 300 proceeds to 308. At 308, input data is given to the thermal system 150 for the state-space modeling.

At 312, the state-space model using the sub-space method is identified (e.g., to specifically construct an output matrix C having a diagonal format). At 316, an LQE (e.g., a Kalman filter observer) is obtained to estimate the states of the state-space model at a sampling time. At 320, the thermal system 150 flows (e.g., coolant pump flows) are calculated using the Kalman filter and the matrix diagonal properties. At 324, the control system 128 applies an optimal control (e.g., LQR) to compute gains and positions of the various actuators 136 associated with the thermal system 150. At 328, the control system 128 utilizes the final gain-tuned LQG control scheme for improved control of the thermal system 150, thereby decreasing costs and/or decreasing vehicle energy consumption (improving efficiency). The method 300 then ends. It will be appreciated that while many of the steps are described as being performed at the control system 128 of the EV 100, that some of the steps (e.g., steps 304-324) could be performed by an external computing system (e.g., a calibration system) and then loaded into the control system 128 of the EV 100 for subsequent online usage.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for a thermal system of a vehicle, the control system comprising:
a set of sensors configured to measure a set of operating parameters of the thermal system and a set of actuators configured to control flow and temperature of a coolant through the thermal system; and
a controller configured to perform linear-quadratic-Gaussian (LQG) optimal control of the thermal system by:
generating, using the set of sensors and the set of actuators and a sampling time, inputs for a state-space model of the thermal system,
identifying the state-space model of the thermal system using a sub-space method,
obtaining a Kalman filter to estimate states of the state-space model at each sampling time,
calculating flows through the thermal system using estimated states and diagonal matrix properties, and
applying an optimal control to compute a gain and values of each of the set of actuators at each sampling time.

2. The control system of claim 1, wherein the vehicle is an electrified vehicle (EV) and the thermal system is associated with one or more electric drive modules (EDMs) of the EV.

3. The control system of claim 2, wherein the thermal system is a low temperature loop (LTL) associated with a front EDM, a rear EDM, and an integrated dual charging module (IDCM) of the EV.

4. The control system of claim 3, wherein:
the set of actuators and the includes first and second pumps, a radiator fan, and a valve and the set of sensors include a pump inlet temperature sensor;
the inputs to the state-space model include speeds of the first and second pumps and the radiator fan and a position of the valve; and
the outputs of the state-space model include fluid flow through the first and second pumps and coolant temperature.

5. The control system of claim 4, wherein the generating of the input data for and the identifying of the state-space model using the sub-space method further includes using pseudorandom binary sequences (PRBS) for generating the inputs.

6. The control system of claim 4, wherein the identifying of the state-space model using the sub-space method includes constructing a matrix having a diagonal format.

7. The control system of claim 1, wherein the controller is configured to perform the LQG optimal control of the thermal system using the computed gains and values for the set of actuators.

8. The control system of claim 7, wherein the LQG optimal control of the thermal system decreases vehicle energy consumption due to inaccurate control of the thermal system.

9. The control system of claim 1, wherein the controller is configured to perform the LQG optimal control of the thermal system without using empirical calibration data stored in look-up tables (LUTs).

10. An optimal control method for a thermal system of a vehicle, the optimal control method comprising:
providing a set of sensors configured to measure a set of operating parameters of the thermal system and a set of actuators configured to control flow and temperature of a coolant through the thermal system; and
performing, by a controller of the vehicle, linear-quadratic-Gaussian (LQG) optimal control of the thermal system by:
generating, using the set of sensors and the set of actuators and a sampling time, inputs for a state-space model of the thermal system,
identifying the state-space model of the thermal system using a sub-space method,
obtaining a Kalman filter to estimate states of the state-space model at each sampling time,
calculating flows through the thermal system using the estimated states and diagonal matrix properties, and
applying an optimal control to compute a gain and values of each of the set of actuators at each sampling time.

11. The optimal control method of claim 10, wherein the vehicle is an electrified vehicle (EV) and the thermal system is associated with one or more electric drive modules (EDMs) of the EV.

12. The optimal control method of claim 11, wherein the thermal system is a low temperature loop (LTL) associated with a front EDM, a rear EDM, and an integrated dual charging module (IDCM) of the EV.

13. The optimal control method of claim 12, wherein:
the set of actuators and the includes first and second pumps, a radiator fan, and a valve and the set of sensors include a pump inlet temperature sensor;
the inputs to the state-space model include speeds of the first and second pumps and the radiator fan and a position of the valve; and
the outputs of the state-space model include fluid flow through the first and second pumps and coolant temperature.

14. The optimal control method of claim 13, wherein the generating of the input data for and the identifying of the state-space model using the sub-space method further includes using pseudorandom binary sequences (PRBS) for generating the inputs.

15. The optimal control method of claim 13, wherein the identifying of the state-space model using the sub-space method includes constructing a matrix having a diagonal format.

16. The optimal control method of claim 10, wherein the controller is configured to perform the LQG optimal control of the thermal system using the computed gains and values for the set of actuators.

17. The optimal control method of claim 16, wherein the LQG optimal control of the thermal system decreases vehicle energy consumption due to inaccurate control of the thermal system.

18. The optimal control method of claim 10, wherein the controller is configured to perform the LQG optimal control of the thermal system without using empirical calibration data stored in look-up tables (LUTs).
